(19) United States
(12) Patent Application Publication
(10) Pub. No.: US 2008/0190503 A1
(43) Pub. Date: Aug. 14, 2008

(54) Flow Switching on a Multi-Structured Microfluidic Cd (Compact Disc) Using Coriolis Force

(75) Inventors: Jim V. Zoval, Lake Forest, CA (US); Marc J. Madou, Irvine, CA (US); Horacio Kido, Niland, CA (US); Guangyao Jia, Irvine, CA (US); Jitae Kim, Irvine, CA (US)

Correspondence Address: Vista IP Law Group LLP, 2040 MAIN STREET, 9TH FLOOR, IRVINE, CA, 92614, US

(73) Assignee: The Regents Of The University Of California, Oakland, CA (US)

(21) Appl. No.: 11/816,746

(22) PCT Filed: Feb. 28, 2006
(86) PCT No.: PCT/US2006/007119

§ 371 Date: Aug. 21, 2007

Related U.S. Application Data
(60) Provisional application No. 60/657,760, filed on Mar. 2, 2005.

(51) Int. Cl. F15C 3/00

(52) U.S. Cl. 137/829

(57) ABSTRACT

A microfluidic switching device includes a planar substrate having a central axis of rotation and a radially-oriented microchannel disposed in the planar substrate that terminates at a junction. In one aspect, the junction is formed as a double-layered junction in which an upstream portion is vertically offset from a downstream portion. In addition, the upstream portion has a smaller effective center of cross-sectional area than the downstream portion. First and rotation second outlet chambers are coupled at one end to the junction. The device is rotated about the central axis in a clockwise direction so as to cause the fluid in the reservoir to flow into the first (right) outlet chamber or in a counter-clockwise direction so as to cause the fluid in the reservoir to flow into the second (left) outlet chamber.

### REFERENCE TO RELATED APPLICATIONS

This Application claims priority to U.S. Provisional Patent Application No. 60/657,760 filed on Mar. 2, 2005. U.S. Provisional Patent Application No. 60/657,760 is incorporated by reference as if set forth fully herein.

### FIELD OF THE INVENTION

The field of the invention generally relates to microfluidic devices and methods used to gate or switch fluids into different flow paths or channels. More specifically, the field of the invention relates to methods and devices for switching the direction of fluid flow in a microfluidic structure having a common inlet and two outlet channels embedded in a microfluidic device such as a microfluidic compact disc (CD).

### BACKGROUND OF THE INVENTION

Microfluidic devices are becoming increasingly more important in both research and commercial applications. Microfluidic devices, for example, are able to mix and react reagents in small quantities, thereby minimizing reagent costs. These same microfluidic devices also have a relatively small size or “footprint,” thereby saving on laboratory space. For example, microfluidic devices are increasingly being used in clinical applications. Finally, because of their small scale, microfluidic devices are able to quickly and cost effectively synthesize products which can later be used in research and/or commercial applications.

For many microfluidic-based devices, there is a need to valve or switch fluids from one flow path to another. Typically, the valving or gating of a liquid in microfluidic-based systems has been exploited using internal actuating components (e.g., piezoelectric, pneumatic, or magnetic-assisted mechanisms). However, such switching modalities require additional fabrication steps to manufacture the device, thereby imposing higher costs and more complexity with respect to integration. There thus is a need for a reliable method and device for valving or switching fluid flow from one path to another. The switching method may advantageously be incorporated into microfluidic-based devices. Similarly, there is a need for a microfluidic switch that can be created with a minimum number of fabrication steps. Moreover, the switch preferably has few, if any, moving components that would add to the complexity of the switch.

### SUMMARY OF THE INVENTION

In a first aspect of the invention, a method of switching fluid flow in a microfluidic device includes the steps of providing a rotationally driven substrate having a radially-oriented microchannel disposed in the substrate. The radially-oriented microchannel terminates at a junction point branching into a first outlet channel and a second outlet channel. In one embodiment, the channels are formed as an inverted Y on the substrate. Fluid is provided in communication with the radially-oriented microchannel, for example, by a coupled reservoir or other microchannel. The substrate is then rotated about a central axis in a clockwise direction so as to cause the fluid to flow into the first outlet channel and rotated about the central axis in a counter-clockwise direction so as to cause fluid to flow into the second outlet channel.

In one aspect of the invention, the rotationally driven substrate is rotated at a relatively low angular frequency, e.g., at or above about 90 rad/second. The rotationally driven substrate may be formed, for example, from a compact disc (CD) that is rotationally driven via a rotatable platen or the like. In still another aspect of the invention, the various channels may be connected to chambers or other channels. For example, the radially-oriented microchannel may terminate at an end opposite the junction into a sample or reservoir chamber. Likewise, the first and second outlet channels may terminate into respective first and second outlet chambers. In still other aspects of the invention, first and second outlet chambers may be coupled directly the junction point.

In still another embodiment, the junction point is formed as a double-layered junction. For example, the double-layered junction may include an upstream microchannel or portion that is vertically offset or elevated from a downstream microchannel or portion. In still another aspect, the upstream microchannel or portion has a cross-sectional area that is less than the cross-sectional area of the downstream microchannel or portion.

In yet another aspect of the invention, a microfluidic switch includes a planar substrate having a central axis of rotation. A radially-oriented microchannel is disposed in the planar substrate and terminates at one end in a junction. First and second outlet chambers, respectively, are coupled to the junction and are used to collect the switched fluid. The first and second outlet chambers may be coupled directly to the junction or indirectly through microchannels or the like. The planar substrate may comprise a CD that is rotated via rotatable platen. A motor, servo, or the like may be used to rotate the platen which, in turn, rotates the CD. Preferably, the motor or other driving device can be controlled to change the rotational direction as well as the speed (or frequency) of rotation.

In one aspect of the invention, the junction forms a double-layered junction having an upstream portion that is vertically offset or elevated from a downstream portion. The upstream portion, in one embodiment, has a cross-sectional area that is less than the cross-sectional area of the downstream portion. The double-layered nature of the junction has several advantages including: (1) reducing the contact area of the fluid within the device to promote the transfer of the fluid into the desired outlet chamber, (2) maximizing the Coriolis force and thus flow rate at a given angular frequency of the device, and (3) mitigating or eliminating any cross-talk between the two outlets.

In still another aspect of the invention, the device may be incorporated with an imaging system that is able to view certain and/or analyze selected regions (e.g., outlet chambers) of the substrate. For example, a camera operable connected to an imaging system may be able to detect and quantify the presence or absence of specific chemical or biological species. To this end, the device may be also be used to sort or separate solutions. As one example, the device may be used in affinity-based separation techniques (e.g., adsorption of nucleic acids on silica matrix followed by elution). Consequently, the device may be used in rapid bioassays and other biomedical diagnostic applications that require the extraction of specific target biomolecules.

It is thus an object of the invention to provide a device and method capable of switching or gating liquids in a microfluidic environment that utilizes the Coriolis force. It is a related object of the invention to provide binary switch capable of switching fluid paths into one of two potential branch paths. It is still another object of the invention to provide CD-based microfluidic switch that is able to switch fluid flow paths at relatively low angular frequencies. It is yet another object of the invention to provide a CD-based microfluidic switch that is able to mitigate or eliminate cross-talk or contamination between the two downstream braches or chambers caused by residual fluid. Further features and advantages will become apparent upon review of the following drawings and description of the preferred embodiments.

### BRIEF DESCRIPTION OF THE DRAWINGS

FIG. 1 illustrates an exemplary substrate on which the microfluidic switch of the present invention is located. FIG. 1 illustrates the Coriolis force (F_{cor}) and the centrifugal force (F_{cen}) operating on a unit volume of fluid positioned within a radially-oriented microchannel.

FIG. 2A illustrates a plan view of a rotationally driven substrate (e.g., CD) including a microfluidic switch thereon.

FIG. 2B illustrates a magnified view of a microfluidic switch according to one embodiment the present invention. The orientation of the switch with respect to the center of rotation of the substrate is shown.

FIG. 3A illustrates a cross-sectional view taken along the line A-A′ in FIG. 2B.

FIG. 3B illustrates a cross-sectional view taken along the line B-B′ in FIG. 2B.

FIG. 4 illustrates one embodiment of a microfluidic switch having the double-layered junction. FIG. 4 also shows a magnified scanning electron microscope (SEM) image of the double-layered junction.

FIG. 5 illustrates a process flowchart for fabricating a rotationally driven substrate using a PDMS molding technique.

FIG. 6 illustrates a system for rotating a substrate containing a switch. FIG. 6 also illustrates an optional imaging system than may be used.

FIG. 7 illustrates a photograph of a CD containing a switch spinning in the counter-clockwise direction. Fluid is shown passing into the left outlet chamber.

FIG. 8 illustrates a photograph of a CD containing a switch spinning in the clockwise direction. Fluid is shown passing into the right outlet chamber.

FIG. 9 illustrates a photograph of a switch having a planar junction. The photograph shows an unwanted liquid plug present in the left branch channel.

### DETAILED DESCRIPTION OF THE INVENTION

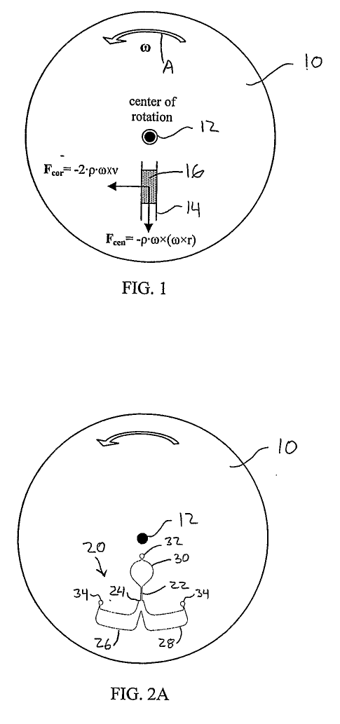

FIG. 1 illustrates a rotationally driven substrate 10 in the form of a compact disc (CD). In the embodiment illustrated in FIG. 1, the substrate 10 is generally circular in shape and is rotatable about a center of rotation 12. The substrate 10 may be formed from any number of materials commonly used to form microfluidic-based devices. In addition, as described in more detail below, the substrate 10 may be formed from a composite structure having a series of separate layers that are used to form the features within the substrate 10. FIG. 1 illustrates a portion of a radially-oriented microchannel 14 disposed within the substrate 10 and having a unit volume of fluid 16 or liquid contained therein. The substrate 10 is shown by arrow A to be rotating about the center of rotation in the counter-clockwise direction with an angular frequency ω.

Two primary forces act upon the unit volume of fluid 16 contained in the radially-oriented microchannel 14. The first force is the centrifugal force (F_{cen}) and tends to force or push the fluid 16 outwardly in the radial direction as shown in FIG. 1. The centrifugal force (F_{con}) is represented by the following formula where ρ represents density of the fluid, ω is the angular frequency, and r is the radial distance of the unit volume of liquid.

F_{cen}=−ρ·ω×(ω×r) (1)

The second force is the Coriolis force (F_{cor}) which tends to push the fluid 16 normal or orthogonal with respect to the rotational direction of the substrate 10. The Coriolis force (F_{cor}) where ν represents the velocity of the unit volume of liquid.

F_{cor}=−2ρ·ω×ν (2)

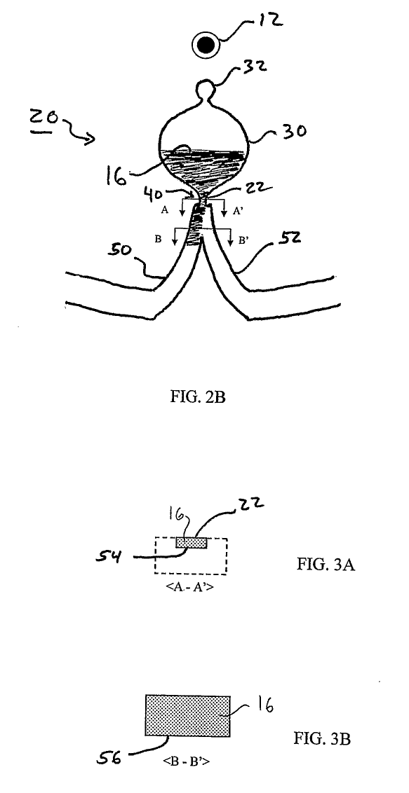

FIG. 2A illustrates a substrate 10 of the type described herein having a single fluidic switch 20. According to this embodiment, the switch 20 is formed as an inverted “Y” with a radially-oriented microchannel 22 branching at a junction point 24 into first and second outlet chambers 26, 28. In one aspect, the first and second outlet chambers are symmetrically arranged with respect to the radially-oriented microchannel 22. The radially-oriented microchannel 22 may be coupled to a fluid reservoir 30 used to retain or otherwise temporarily store fluid 16. The fluid reservoir 30 may include a vent hole or port 32. The vent hole or port 32 may also be used to fill the reservoir 30. Of course, the radially-oriented microchannel 22 and/or the fluid reservoir 30 may be coupled to other microchannels or chambers (not shown). This is particularly so if the substrate 10 were formed with multiple features, for example, if the substrate 10 were used in complex sample preparation and analysis. FIG. 2A also shows that the first and second outlet chambers 26, 28 include outlet vent ports 34. The vent ports 34 may also be used to remove fluid 16. Alternatively, the chambers 26, 28 may coupled to one or more microchannels that may be used to transfer fluid to further features contained on the substrate 10.

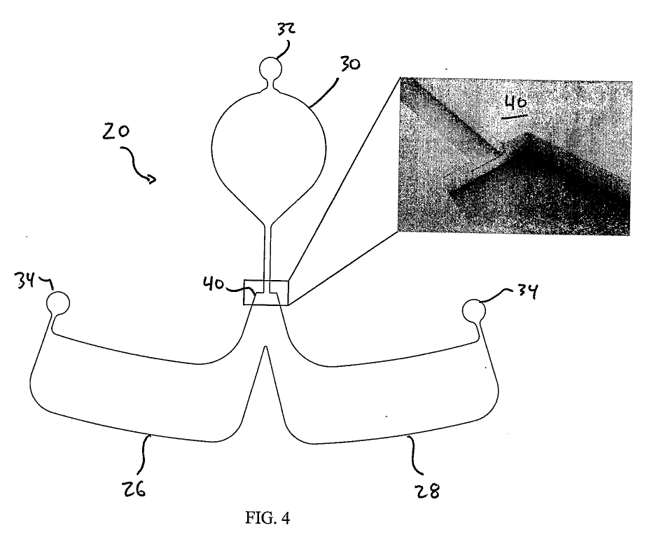

FIG. 2B illustrates a magnified view of a switch 20 according to another aspect of the invention. The switch 20 is disposed about a center of rotation 12 and includes a radially-oriented microchannel 22 that terminates at one end in a double-layered junction 40. The opposing end of the microchannel 22 is coupled to a fluid reservoir 30. The double-layered junction 40 is a non-planar junction formed by the intersection of the radially-oriented microchannel 22 with first and second outlet channels 50, 52 (as shown in FIG. 2B) or first and second outlet chambers 26, 28 (e.g., of the type shown in FIGS. 2A, 4). According to one embodiment of the invention, the radially-oriented microchannel 22 is vertically offset or elevated with respect to the outlet channels 50, 52 or, alternatively, first and second outlet chambers 26, 28.

FIG. 3A illustrates a cross-sectional view of the radially-oriented microchannel 22 taken along the line A-A′ in FIG. 2B. This cross-sectional view is immediately upstream of the double-layered junction 40. The cross-sectional view of line B-B′ shown in FIG. 3B is shown in phantom. FIG. 3B is a cross-sectional view of the region of the switch 20 that is immediately downstream from the double-layered junction 40. As best seen in FIGS. 3A and 3B, the radially-oriented microchannel 22 is vertically offset from the first and second outlet channels 50, 52. In this regard, the lower surface 54 of the radially-oriented microchannel 22 is higher or elevated with respect to the lower surface 56 of the first and second outlet channels 50, 52. In addition, according to one embodiment of the invention, the cross-sectional area of the radially-oriented microchannel 22 is smaller than the cross-sectional area immediately downstream from the double-layered junction 40 (e.g., the region shown in FIG. 3B).

The double-layered junction 40 in the switch 20 provides an advantage over a planar junction point. The advantages include: (1) reducing the contact area of the fluid 16 within the junction region of the switch 20 to promote the transfer of the fluid 16 into the desired outlet chamber or outlet channel, (2) maximizing the Coriolis force and thus flow rate of the fluid 16 at a given angular frequency of the device, and (3) mitigating or eliminating any cross-talk or contamination of fluid 16 between the two outlet channels 50, 52 (or outlet chambers 26, 28).

FIG. 4 illustrates a magnified view of a switch 20. In the embodiment illustrated in FIG. 4, the double-layered junction 40 is coupled at the downstream side to first and second outlet chambers 26, 28. In this embodiment, there are no microchannels per se that connect to the downstream end of the double-layered junction 40. FIG. 4 also illustrates a magnified scanning electron microscope (SEM) image of the double-layered junction 40. The tiered or vertically offset nature of the double-layered junction is clearly seen 40.

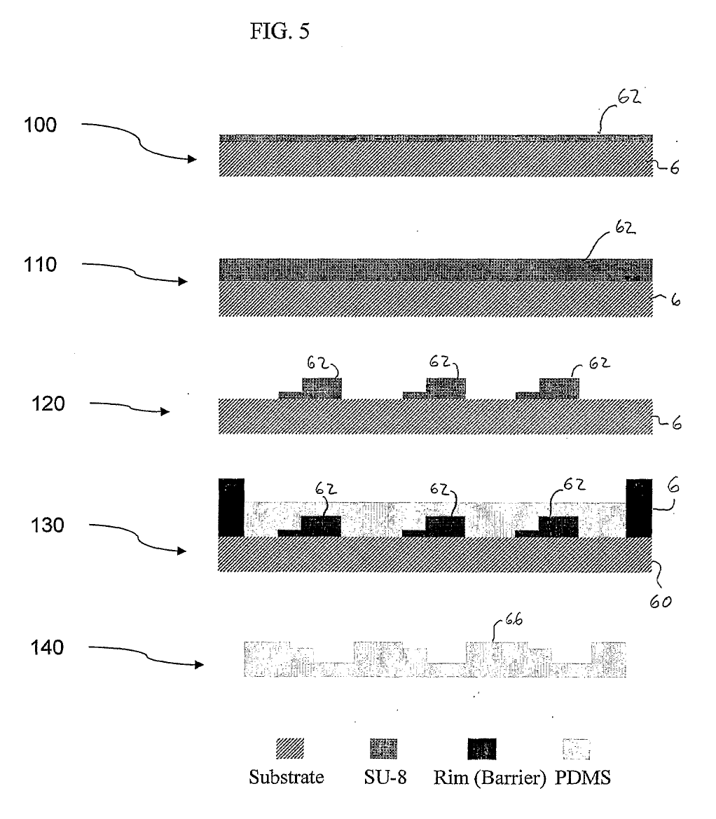

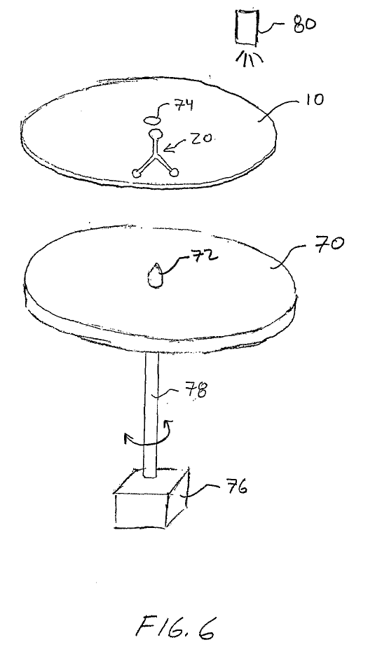

FIG. 5 illustrates one method of forming substrate 10 having a switch 20 therein. The method illustrated in FIG. 5 uses a molded elastomer to form the features of the microfluidic switch 20. It should be understood, however, that other fabrication techniques known to those skilled in the microfluidic arts may be used to form one or more switches 20 on a rotatable substrate 10. For example, Computer Numerical Control (CNC) machining may be used to fabricate the devices. Alternatively, microfluidic patterns may be photographically etched in a dry film resist that is laminated between two outer plastic discs.

Referring to FIG. 5, in step 100 a substrate 60 such as a Silicon wafer is provided and a negative tone photoresist 62 such as SU-8 (NANO SU-8 available from MicroChem, Corp., Newton, Mass.) is deposited on an upper surface of the substrate 60 by spin coating. The substrate 60 (with SU-8) is then subject to a pre-baking process to evaporate the solvent and densify the film. For example, for a 100 μm thickness, the substrate 60 is heated at around 65° C. for around 10 minutes. A typical thickness for the first application of photoresist 62 is around 160 μm.

After pre-baking, a mask is interposed between the substrate 60 and a UV light source (not shown) to expose selective portions of the photoresist 62. Typical wavelengths usable to cross-link SU-8 fall within the range of about 350 nm to about 400 nm. The UV light serves to cross-link certain portions of the photoresist 62 that will ultimately become the features of the switch 20. For example, the first UV light exposure is used to form the features that will ultimately form the reservoir 30 and radially-oriented microchannel 22.

Referring to step 110 in FIG. 5, after the initial UV light exposure, the mask is removed and a second layer of photoresist 62 is applied to the substrate 60 by spin coating. The second layer of photoresist 62 may have a thickness if around 270 μm. Another pre-baking operation is performed to again evaporate the solvent and densily the film (typically at around 65° C.) for several minutes. A second, different mask is then interposed between the substrate 60 and the UV light source to selectively expose predetermined areas of the photoresist 62. The second UV exposure is used to form the outlet chambers 26, 28 (e.g., having a thickness of 430 μm) and/or outlet channels 50, 52 as well as the double-layered junction 40. The substrate 60 then undergoes a post-exposure bake heating operation wherein the substrate is heated to around 65° C. to around 95° C. for several minutes to solidify the photoresist 62.

Next, as seen in step 120, the substrate 60 is immersed in a developing or etching solution (available from MicroChem Corp.) to remove the unexposed areas of the photoresist 62. Actual developing time depends on the thickness of the photoresist 62. For a photoresist layer 62 having a 150 μm thickness, the immersion time is around 15 to 20 minutes. Other solvent-based developing solutions that may be used include ethyl lactate and diacetone alcohol. For high aspect ratio structures, agitation of the solution may be required.

Now referring to step 130, the substrate 60 is placed into a holding ring 64 that includes a circumferential rim that acts as a barrier to retain the polydimethylsiloxane (PDMS) precursor over the top of the substrate 60. The PDMS precursor along with a curing agent (Sylgard 185, Dow Corning, Midland, Mich.) are then mixed thoroughly in a weight ratio of 10:1, respectively. After degassing the mixture in vacuum, the mixture is poured and cured on the SU-8 master mold. The mold may be heated to accelerate the curing process.

As seen in step 140, after curing, the PDMS layer 66 containing the switch 20 features is then peeled off the master mold. To form the complete substrate 10, the PDMS layer 66 is then sandwiched between two polycarbonate discs using a double-sided adhesive film.

FIG. 6 illustrates an apparatus used to rotate the now formed substrate 10. The apparatus includes a support or platen 70 on which the substrate 10 rests. The platen 70 is rotational about its central axis in either the clockwise or counter-clockwise directions. In one embodiment, the platen 70 may have a spindle 72 that passes partially or completely through a hole 74 formed in the substrate 10. The platen 70 may be connected to a motor or servo 76 via a shaft 78 that is used to drive the platen 70 and thus the substrate 10. The motor or servo 76 is a bidirectional such that platen 70 is able to spin in either the clockwise or counter-clockwise directions. In addition, the speed of the motor or servo 76 is preferably controllable such that the angular rotational frequency can be controlled. For example, the motor or servo 76 may be connected to a computer such as a PC (not shown) that can control the rotational parameters (e.g., rotational speed, sequence, timing, etc.).

Still referring to FIG. 6, an imaging system 80 may be incorporated into the system. The imaging system 80 may include, for example, a radiation source used to fluoresce one or more components within the fluid 16. The imaging system 80 may also include imaging means such as, for instance, a camera or charged coupled device (CCD) or the like that can be used to selectively view one or more regions of the substrate 10 (e.g., outlet chambers 26, 28). In addition, the imaging system 80 may include image analysis software that is used in the automatic analysis and detection of certain species or components contained within the fluid 16.

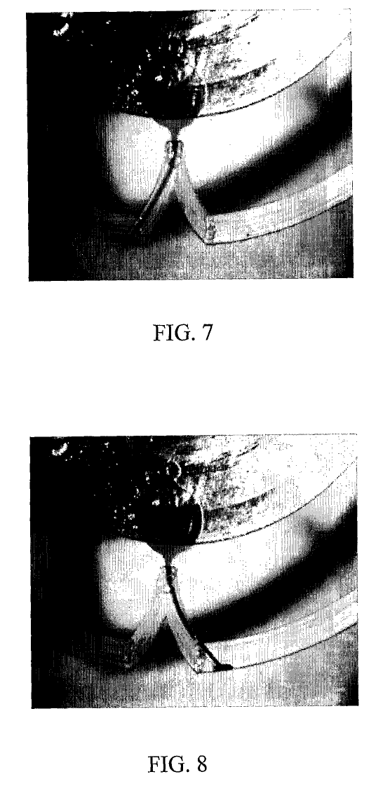

FIGS. 7 and 8 illustrate images of a switch 20 used to selectively pass a fluid 16 into one of two outlet channels 50, 52. In FIG. 7, the substrate 10 containing the switch 20 is rotated in the counter-clockwise direction. Rotation of the substrate 10 in the counter-clockwise direction directs the fluid 16 from the reservoir 30, through the double-layered junction 40, and into a first (left as seen in FIG. 7) outlet channel 50. In contrast, in FIG. 8, the substrate 10 containing the switch 20 is rotated in the clockwise direction. Rotation of the substrate 10 in the clockwise direction causes fluid 16 from the reservoir 30 to pass through the double-layered junction 40 and into the second (right as seen in FIG. 8) outlet channel 52.

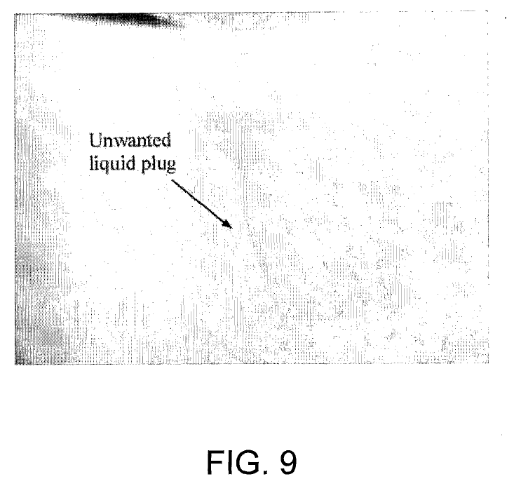

One significant benefit of the double-layered junction 40 used in the switch 20 is that it avoids the introduction of fluid 16 into an unintended channel or outlet chamber. FIG. 9 illustrates an image of a switch 20 utilizing a single-layered or planar junction that was spun in the clockwise direction at 100 rad/sec. As seen in FIG. 9, there is a liquid plug that is located in a portion of the left outlet channel just downstream from the junction. It has been observed that single-layered junctions produce unwanted liquid plugs even at high frequencies (e.g., 310 rad/sec.). This undesirable effect is, however, eliminated by the double-layered junction 40. The ability of the double-layered junction 40 to eliminate cross-talk or contamination is essential in flow switching applications used in bioassays where specific target materials need to be separated without the risk of contamination.

Another advantage of the double-layered junction 40 is that it permits switching to be performed at lower angular frequencies. For example, in one aspect of the invention, the switch 20 utilizing the double-layered junction 40 is able to switch fluids 16 at relatively low angular frequencies, e.g., at or above about 90 rad/sec.

The microfluidic switch 20 described herein can be used in any microfluidic application where binary switching is used or advantageous. For example, the switch 20 can be used in the affinity-based separation of biomolecules in biomedical and clinical diagnostic applications. The switch 20 can also be implemented in rapid bioassays and biomedical diagnostic applications that require the extraction or separation of specific target biomolecules.

While embodiments of the present invention have been shown and described, various modifications may be made without departing from the scope of the present invention. The invention, therefore, should not be limited, except to the following claims, and their equivalents.

What is claimed is:

1. A method of switching fluid flow in a microfluidic device comprising:
providing a rotationally driven substrate having a radially-oriented microchannel terminating at a junction point branching into a first outlet channel and a second outlet channel;
providing a fluid in communication with the radially-oriented microchannel; and
rotating the substrate about a central axis in a clockwise direction so as to cause the fluid to flow into the first outlet channel and rotating the substrate about the central axis in a counter-clockwise direction so as to cause the fluid to flow into the second outlet channel.

2. The method of claim 1, wherein the rotationally driven substrate is rotated at an angular frequency at or above about 90 rad/seconds.

3. The method of claim 1, wherein the rotationally driven substrate comprises a compact disc (CD).

4. The method of claim 1, wherein the substrate is rotationally driven via a rotatable platen.

5. The method of claim 1, wherein the radially-oriented microchannel is connected to a chamber upstream of the junction.

6. The method of claim 1, wherein the first outlet channel terminates in a first outlet chamber.

7. The method of claim 1, wherein the second outlet channel terminates in a second outlet chamber.

8. The method of claim 6, further comprising the step of removing fluid contained in the first outlet chamber.

9. The method of claim 7, further comprising the step of removing fluid contained in the second outlet chamber.

10. The method of claim 1, wherein the junction point comprises a double-layered junction having an upstream portion vertically offset from a downstream portion.

11. The method of claim 10, wherein the upstream portion has a cross-sectional area that is less than the cross-sectional area of the downstream portion.

12. The method of claim 1, wherein the radially-oriented microchannel and the first and second outlet channels are formed as an inverted Y.

13. A method of switching fluid flow in a microfluidic device comprising:
providing a rotationally driven substrate having an radially-oriented upstream channel terminating at a junction into two collection chambers; and
rotating the substrate about a central axis in a clockwise direction so as to cause the fluid to flow down the radially-oriented upstream channel and into the first outlet channel and rotating the substrate about the central axis in a counter-clockwise direction so as to cause the fluid to flow down the radially-oriented upstream channel and into the second outlet channel.

14. The method of claim 13, wherein the rotationally driven substrate is rotated at an angular frequency at or above about 90 rad/seconds.

15. The method of claim 13, wherein the rotationally driven substrate comprises a compact disc (CD).

16. The method of claim 13, wherein the substrate is rotationally driven via a platen.

17. The method of claim 13, wherein the junction comprises a double-layered junction having an upstream portion vertically offset from a downstream portion.

18. The method of claim 13, wherein the upstream portion has a cross-sectional area that is less than the cross-sectional area of the downstream portion.

19. The method of claim 13, wherein the radially-oriented microchannel and the first and second outlet channels are formed as an inverted Y.

20. A microfluidic switching device comprising:
a planar substrate having a central axis of rotation;
a radially-oriented microchannel disposed in the planar substrate that terminates at a junction;
a first outlet chamber coupled at one end to the junction; and
a second outlet chamber coupled at one end to the junction.

21. The device of claim 20, wherein the planar substrate comprises a compact disc (CD).

22. The device of claim 20, wherein the first and second outlet chambers are coupled to the junction via respective microchannels.

23. The device of claim 20, wherein the junction comprises a double-layered junction having an upstream portion vertically offset from a downstream portion.

24. The device of claim 23, wherein the upstream portion of the double-layered junction has a cross-sectional area that is less than the cross-sectional area of the downstream portion.

25. The device of claim 20, further comprising a rotatable platen for rotating the microfluidic switching device about the central axis of rotation.

26. The device of claim 25, further comprising means for rotating the rotatable platen in either the clockwise or counter-clockwise directions.

27. The device of claim 26, wherein the means comprises a motor.

28. The device of claim 20, wherein the first and second outlet chambers are symmetrical.

29. The device of claim 27, wherein a switching threshold rotational frequency of the microfluidic switching device is at or above about 90 rad/seconds.

30. The device of claim 20, further comprising an imaging system.

31. The device of claim 20, further comprising a sample chamber coupled to the radially-oriented microchannel.

32. The device of claim 23, wherein the microfluidic switching device is capable of switching fluids between the first and second outlet chambers with substantially no cross-contamination between the first and second outlet chambers.
